(19) United States
(12) Patent Application Publication
(10) Pub. No.: US 2002/0027688 A1
(43) Pub. Date: Mar. 7, 2002

(54) Fiber optic transceiver employing digital dual loop compensation

(76) Inventor: Jim Stephenson, Thousand Oaks, CA (US)

Correspondence Address: David L. Henty, Myers, Dawes & Andras LLP, Suite 1150, 19900 MacArthur Blvd., Irvine, CA, 92612, US

(21) Appl. No.: 09/907,056

(22) Filed: Jul. 17, 2001

Related U.S. Application Data
(60) Provisional application No. 60/230,130, filed on Sep. 5, 2000.

(51) Int. Cl. H04B 10/00; H04B 10/04

(52) U.S. Cl. 359/152; 359/180

(57) ABSTRACT

A fiber optic transmitter and/or transceiver adapted for use in an optical fiber data transmission system which is capable of transmitting data at high data rates in burst mode is disclosed. A digital automatic power control circuit stores digital values for modulation and bias laser driver control. These values compensate for variations in laser power due to temperature variations or other factors and are reestablished on a burst by burst basis. The present invention further provides an optical transmitter or transceiver which can provide such capability without added cost or complexity. The optical transmitter or transceiver is further capable of operating in both burst and continuous modes.

### RELATED APPLICATION INFORMATION

The present application claims priority under 35 USC 119 (e) of provisional application serial No. 60/230,130 filed Sep. 5, 2000 the disclosure of which is incorporated herein by reference.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers”) throughout the fiber optic distribution network. Depending on the specific implementation of the fiber optic network the optical transceivers may operate in a continuous mode or in a burst mode. Also, depending on the specific architecture of the fiber optic network a given receiver may be coupled to receive data from one or a relatively large number of individual transmitters.

Referring to FIGS. 1A and 1B, typical continuous mode and burst mode data transmission patterns are illustrated, respectively. As illustrated in FIG. 1A, in a typical continuous mode data transmission pattern the modulated optical power levels correspond to the encoded data. For example, NRZ (Non Return to Zero) encoding is common in fiber optic distribution networks. In the example of FIG. 1, a high optical power level corresponds to a “1” while a low optical power level corresponds to a “0”, as illustrated in the diagram. Various other encoding techniques may be employed, however, as will be appreciated by those skilled in the art. In any case, in continuous mode transmission the power level corresponding to a high signal will be relatively constant, or at least relatively slowly varying, over time. This allows the receiver to lock onto the optical power levels corresponding to the high and low signals and allows the receiver to relatively easily discriminate the encoded data from the modulated light pulses. Continuous mode transmission may typically be employed where a fiber is not shared by two transmitters or where wavelength division multiplexing is employed to share a fiber.

In FIG. 1B, a representative burst mode data pattern is illustrated corresponding to first and second data bursts provided from the transmitter of a single transceiver. As illustrated a typical data burst or packet comprises a relatively short, high density burst of data. Each burst is typically followed by a relatively long period during which the transmitter is asleep, before the next data burst. During this sleep period another transmitter may be active on the same fiber. Such burst transmission may thus allow multiple transceivers to share an optical fiber on a time division multiple access (TDMA) basis. Also, such burst transmission may allow one receiver to be coupled to receive data from many transmitters on a time multiplexed basis, whether by sharing of a fiber or with separate fibers. For example, burst transmission may be employed in fiber optic data distribution networks which couple a central data distribution transceiver to multiple end user transceivers on a TDMA basis. Also, continuous and burst transmission may be combined in some fiber optic data distribution networks. For example, a central data distribution transceiver may transmit in a continuous mode, e.g., a cable TV signal, whereas the end user transceivers transmit in a burst mode back to the central data distribution transceiver.

Both burst mode transmission and continuous mode transmission can create difficult constraints on transmitter performance, especially at high data rates. This may be appreciated from FIGS. 1A and 1B. As shown the optical “0” level is not at zero optical power. This is necessary at high data rates since the residual charge in the transmitter laser diode prevents the optical output power from immediately going to zero when the drive current is turned off. Therefore, the 1 to 0 transition at high data rates cannot return to zero power. To distinguish a 1 from a 0 a minimum power ratio between the 1 and 0 optical power levels must be maintained, which ratio is typically referred to as the extinction ratio. For example, a minimum extinction ratio of 10 may typically be required for reliable data recovery. External factors affecting the laser power for a given current may cause the extinction ratio to change, however, potentially falling outside the acceptable range. For example, laser diode optical power output is highly temperature sensitive and ambient temperature variations and/or temperature increases as the transmitter operates may result in unacceptably large variations in the extinction ratio. Also, aging and wear of a transmitter may result in significantly different optical power being provided over time, also potentially reducing the extinction ratio below an acceptable range. These factors can result in data recovery errors or inability to meet specifications for more demanding applications.

To address this problem, feedback control of the laser diode optical power has been provided to compensate for temperature variations and effects of aging and wear. A back facet monitor photodiode is typically used to monitor laser output power and the drive current to the laser diode is adjusted to keep average optical output power relatively constant despite the above noted temperature variations and other factors. Although this can address the problem to some degree, the effect of temperature and/or aging and wear may not be the same for the 0 optical power level as the 1 level. Therefore, the extinction ratio may change despite the use of feedback control.

Dealing with the variation of the extinction ratio becomes a much more serious problem for high data rate burst transmission. As shown in FIG. 1B each transmitter is awake for a very short period of time corresponding to the transmitter's time slot in a TDMA system. When the transmitter turns on at the beginning of a burst the feedback loop employed for optical power stabilization must have time to reestablish itself. This closing of the feedback loop may take a millisecond or more. In a high capacity burst transmission TDMA network application, however, the total time slot available for the transmitter to send a burst may be less than a millisecond, for example, several microseconds. Therefore, the feedback loop never has time to close and the extinction ratio problem cannot be adequately solved in this way. Alternatively, the transmitter may be left on but at the zero level between bursts. This approach is not effective, however, since the average power during normal operation is an average of the 1 and 0 levels and cannot be stabilized at the zero level. Also, in applications employing burst transmission one receiver may be coupled to many transmitters operating in burst mode in respective time slots. If all these transmitters are left on at the zero level they may nonetheless sum to create a false high level. E.g., if the extinction ratio is 10, then 10 transmitters left on at the zero level would create a false one. Therefore, during the time period the transmitter is asleep in FIG. 1B it must turn off to zero optical power as quickly as possible.

From the above it will be appreciated that high data rate optical fiber data transmission systems present extremely difficult problems for transmitter design. In particular, burst transmission systems or combined burst and continuous systems pose particularly difficult problems for transmitter design. Also, it is extremely important to provide solutions to these problems without significantly increasing the costs of the system.

Accordingly, it will be appreciated that a need presently exists for an optical transmitter and/or transceiver capable of transmitting data at high densities in burst mode which can address the above noted problems. It will further be appreciated that a need presently exists for such an optical transmitter or transceiver which can provide such capability without added cost or complexity. It will further be appreciated that a need presently exists for an optical transmitter or transceiver capable of operating in both burst and continuous mode.

### SUMMARY OF THE INVENTION

The present invention provides an optical transmitter and/or transceiver adapted for use in an optical fiber data transmission system which is capable of transmitting data at high densities in burst mode. The present invention further provides an optical transmitter or transceiver which can provide such capability without added cost or complexity. The present invention further provides an optical transmitter or transceiver capable of operating in both burst and continuous mode.

In a first aspect the present invention provides an optical transmitter, comprising a laser diode, a laser driver having a data input for receiving input data and providing a drive signal to the laser diode corresponding to the input data, a laser diode power monitoring photodiode for monitoring the laser optical output power and providing a laser power monitoring signal, and an automatic power control circuit. The automatic power control circuit is coupled to receive the laser power monitoring signal and comprises a comparator for comparing the monitored laser power to a reference level and a control circuit coupled to the comparator output. The control circuit provides a digital power control value corresponding to the difference between the monitored laser power and the reference level. The digital power control value is employed to provide a power control signal to the laser driver to control laser optical output power.

Preferably, the automatic power control circuit further comprises a nonvolatile storage for storing the reference level as a digital reference value and a memory for storing the digital power control value. The same nonvolatile storage may be employed for the memory, for example, an EEPROM may be employed for storage of both digital values. In one preferred optical networking application the transmitter transmits bursts of modulated light and the digital power control value is stored between bursts. This allows the power control to be immediately reestablished in consecutive bursts and delays associated with closing of a feedback loop are avoided. This in turn allows effective power control even for short duration bursts.

In a further aspect the optical transmitter may include a shut-off circuit, coupled to the automatic power control circuit, for shutting off the laser driver if the monitored laser power exceeds a preset safety level. In a preferred embodiment the shut-off circuit may comprise a laser power monitoring circuit receiving a laser power monitoring signal from the automatic power control circuit and a shut-off circuit latch. The shut-off circuit may further comprise a laser diode driver current monitoring circuit receiving the laser drive current from the laser driver and the shut-off circuit also shuts off the laser driver if the laser drive current exceeds a preset safety level.

In a preferred embodiment the optical transmitter is implemented with a dual loop digital power control circuit. In particular, the optical transmitter comprises a laser diode and a laser driver providing a drive signal to the laser diode corresponding to input data having a modulation level for a high data input logic level and a lower bias level for a low input logic level. The transmitter includes a laser diode power monitoring photodiode providing a laser power monitoring signal and an automatic power control circuit coupled to receive the laser power monitoring signal. The automatic power control circuit comprises a first comparator for comparing the laser power to a modulation reference level and a second comparator for comparing the laser power to a bias reference level. The automatic power control circuit also includes a control circuit, coupled to the first and second comparators, for providing a digital modulation power control value corresponding to the difference between the laser power for a high input data logic level and the modulation reference level and a digital bias power control value corresponding to the difference between the laser power for a low input data logic level and the bias reference level. The automatic power control circuit controls the modulation level of the laser driver drive signal in response to the digital modulation power control value and controls the bias level of the laser driver drive signal in response to the digital bias power control value. To time the control with the data the control circuit includes a clock input for receiving a clock signal in phase with the input data. This dual loop power control aspect of the present invention allows the modulation and bias levels to be independently controlled. This allows a desired extinction ratio to be preserved despite differing variations in bias and modulation levels.

In a further aspect, the present invention provides a burst mode optical data transmission system. The burst mode optical data transmission system comprises a plurality of transmitters providing burst mode modulated optical signals. This allows the plural transmitters to share a fiber in a TDMA manner. Each of the transmitters includes optical power monitoring means for monitoring the output optical power and digital power control means for controlling the optical power. The digital power control means controls the optical power based on the difference between the monitored output optical power and a reference value. The digital power control means further includes means for storing a digital value corresponding to the control between bursts. The burst mode optical data transmission system further includes at least one optical fiber optically coupled to the transmitters and a receiver optically coupled to the fiber and receiving the burst mode modulated optical signals. Because of the effective power control of the transmitters the saturation of the receiver by multiple low level transmitter outputs in the sleep mode is avoided.

In another aspect the present invention provides a method for transmitting data over an optical network in a burst mode. The method comprises providing modulated light to an optical fiber in an optical network in a burst, the burst comprising a plurality of data bits. The method further employs monitoring the output optical power of the modulated light and comparing the monitored output optical power to a reference value. A digital adjustment value is derived based on the difference between the monitored output optical power and the reference value and the optical power is controlled based on the digital adjustment value.

The transmitter is placed in a low power sleep mode after transmission of the burst and the digital adjustment value is stored until transmission of the next burst.

Accordingly, it will be appreciated that the present invention provides an optical transmitter and/or transceiver adapted for use in an optical fiber data transmission system which is capable of transmitting data at high densities in burst mode. Further features and advantages will be appreciated from a review of the following detailed description of the invention.

### BRIEF DESCRIPTION OF THE DRAWINGS

FIGS. 1A and 1B are optical power vs. timing diagrams illustrating typical continuous and burst mode data transmission waveforms.

FIG. 2 is a block schematic drawing of a dual-fiber fiber optic data transmission system in accordance with the present invention.

FIG. 3 is a block schematic drawing of a single-fiber fiber optic data transmission system in accordance with the present invention.

FIG. 4 is a block schematic drawing of a transceiver coupled to dual optical fibers in accordance with the present invention.

FIG. 5 is a block schematic drawing of a transceiver coupled to a single optical fiber in accordance with the present invention.

FIG. 6 is a block schematic drawing of a digital automatic power control circuit employed in the optical transmitter of the present invention.

FIG. 7 is a block schematic drawing of a control logic circuit employed in the digital automatic power control circuit of FIG. 6.

FIG. 8 is a block schematic drawing of an alternate embodiment of the optical transmitter of the present invention employing an automatic shut-off circuit.

FIG. 9 is a block schematic drawing of an alternate embodiment of the optical transmitter of the present invention employing a digital automatic power control circuit and an automatic shut-off circuit.

FIG. 10 is a block schematic drawing of a digital automatic power control circuit employing an alternate current comparator which could replace the transimpedance amplifier and voltage comparators.

FIG. 11 is a block schematic drawing of an alternate embodiment of the optical transmitter of FIG. 8 employing an alternate shut-off circuit.

### DETAILED DESCRIPTION OF THE INVENTION

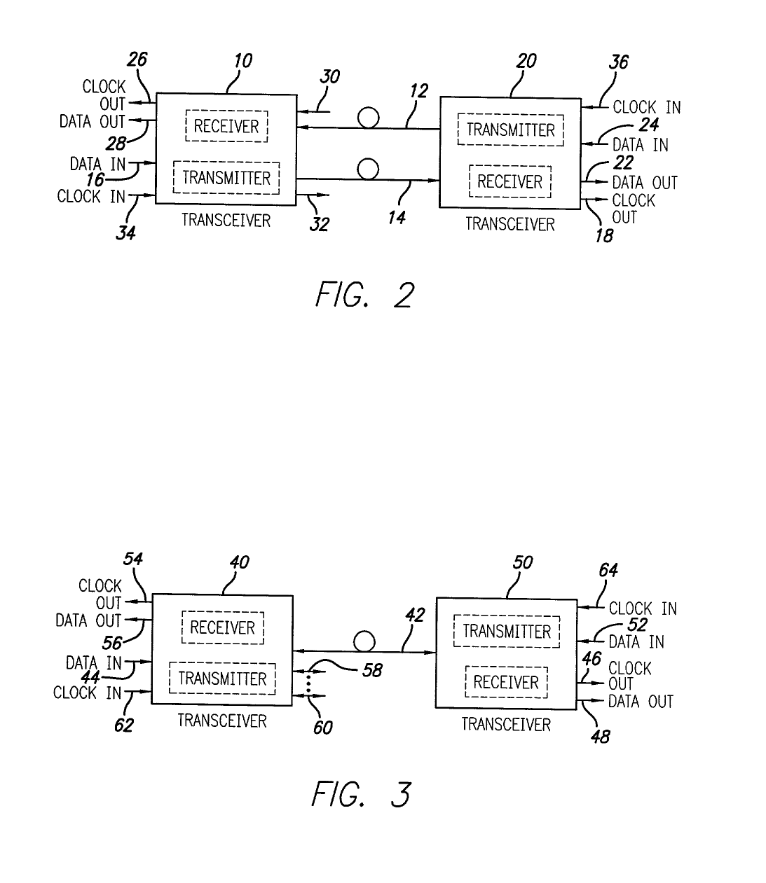

Referring to FIGS. 2 and 3, a high-level block schematic drawing of a fiber optic data transmission system incorporating the present invention is illustrated. FIG. 2 corresponds to a dual fiber data transmission system while FIG. 3 corresponds to a single fiber data transmission system.

Referring first to FIG. 2, a first transceiver 10 is coupled to a second transceiver 20 via first and second optical fibers 12 and 14. As indicated by the arrows on the optical fibers, transceiver 10 transmits data to transceiver 20 in the form of modulated optical light signals along optical fiber 14. The data to be transmitted may be provided to transceiver 10 from an external data source in the form of input electrical data signals along line 16. Transceiver 20 in turn converts the modulated light signals provided along fiber 14 to electrical signals and provides clock and data signals along lines 18 and 22 as illustrated in FIG. 2. Transceiver 20 also receives as an input electrical data signals along line 24 and transmits the data along fiber 12 in the form of modulated light signals to transceiver 10. Transceiver 10 converts the received modulated light signals to electrical signals and provides output clock and data signals along lines 26 and 28, as illustrated. In synchronous systems transceivers 10 and 20 will receive a clock signal along lines 34 and 36, respectively, in which case a clock output along lines 18 and 28 is not necessary.

Both transceiver 10 and transceiver 20 include receiver circuitry to convert optical signals provided along the optical fibers to electrical signals and to detect encoded data and/or clock signals. In various applications data transmission along the optical fibers may be in burst mode or both burst and continuous modes at different times. Also, one fiber may carry data transmitted in burst mode and another in continuous mode. For example, transceiver 10 may transmit data along fiber 14 in a continuous mode whereas transceiver 20 may transmit data back to transceiver 10 along fiber 12 in a burst mode. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 30 and 32 in FIG. 2. For a PON system, the fibers are combined external to the transceiver. The number of such connections is of course not limited to those illustrated and transceiver 10 could be coupled to a large number of separate optical networking units in a given application, and such multiple connections are implied herein. As will be better appreciated from the following discussion, the present invention provides the capability to detect data transmitted in either burst or continuous mode operation in these various fiber optic network applications.

Referring to FIG. 3, a fiber optic transmission system is illustrated employing a single fiber coupling between transceivers 40 and 50. The operation of the transceivers in FIG. 3 is similar to that described in relation to FIG. 2 with the difference that a bidirectional data transmission is provided along fiber 42. For example, wavelength division multiplexing may be employed. If wavelength division multiplexing is employed transceiver 40 may provide data transmission to transceiver 50 employing a first wavelength of light modulated and transmitted along fiber 42 and transceiver 50 may provide data along fiber 42 to transceiver 40 employing a second wavelength of light. Alternatively transmission in the two directions may be provided in accordance with time division multiplexing or using other protocols. Input electrical data signals may be provided along line 44 from outside data source to transceiver 40 for transmission to transceiver 50 as modulated light signals. Transceiver 50 in turn receives the light pulses, converts them to electrical signals and outputs clock and data signals along lines 26 and 48 respectively. Transceiver 50 similarly receives input electrical data signals along line 52, converts them to modulated light signals and provides the modulated light signals along fiber 42 to transceiver 40. Transceiver 40 receives the modulated light pulses, converts them to electrical signals and derives clock and data signals which are output along lines 54 and 56, respectively. Also, clock inputs along lines 62 and 64 may be provided in a synchronous system. As in the case of the previously described embodiment of FIG. 2, the present invention provides the capability for either burst or continuous mode operation or both at different times. Also, as in the embodiment described above, one or more of transceivers 40 and 50 may be coupled to a plurality of additional transceivers and receive or transmit data to such transceivers along additional fibers 58 and 60, as illustrated in FIG. 3. It will further be appreciated that additional fiber coupling to additional transceivers may also be provided for various applications and architectures and such are implied herein.

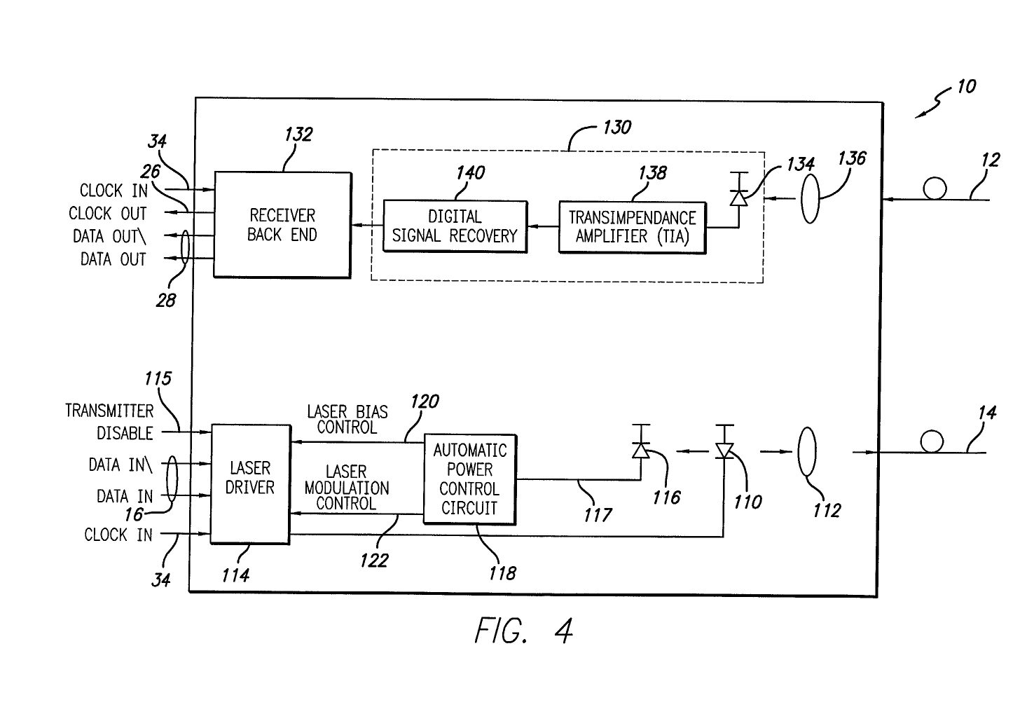

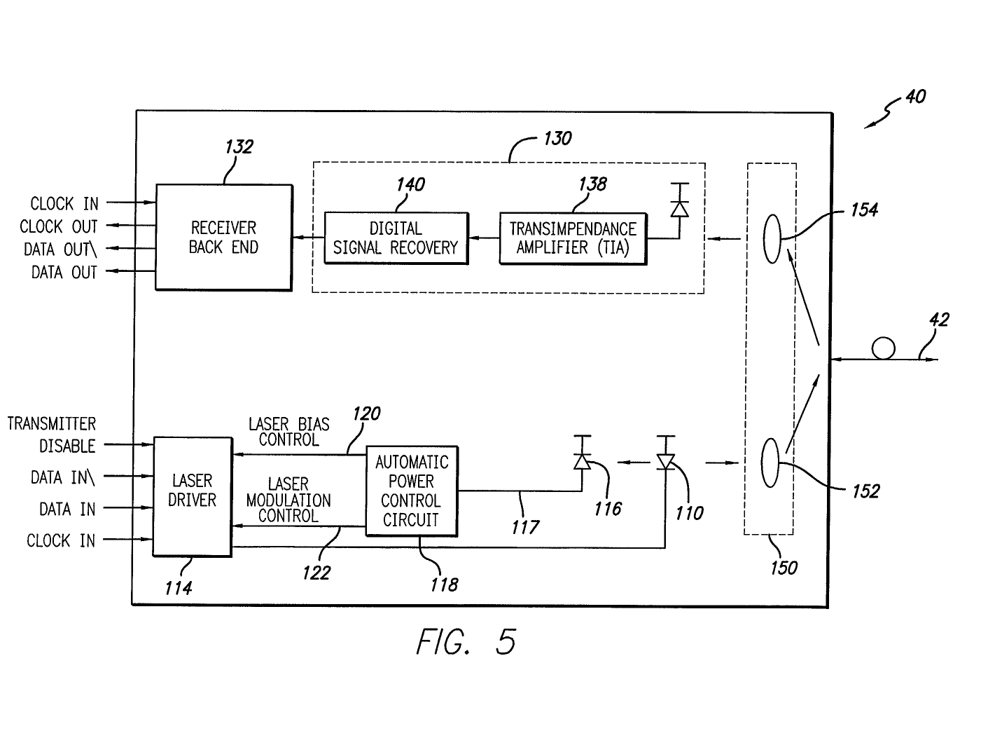

Referring to FIG. 4, a block schematic drawing of a transceiver coupled to dual optical fibers in accordance with the present invention is illustrated. The transceiver illustrated in FIG. 4 may correspond to either transceiver 10 or 20 illustrated in FIG. 2 although it is denoted by reference numeral 10 in FIG. 4 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated, the transmitter portion of transceiver 10 includes a laser diode 110 which is coupled to transmit light into optical fiber 14 via passive optical components illustrated by lens 112 in FIG. 4. Passive optical components in addition to lens 112 may also be employed as will be appreciated by those skilled in the art. Laser diode 110 is coupled to laser driver 114 which drives the laser diode in response to the data input provided along lines 16 to provide the modulated light output from laser diode 110. In particular, the laser driver provides a modulation drive current, corresponding to high data input values (or logic 1), and a bias drive current, corresponding to low data input values (or logic 0). Normally the bias drive current will not correspond to zero laser output optical power. Various modulation schemes may be employed to encode the data, for example, NRZ encoding such as described above may be employed as well as other schemes well known in the art. In addition to receiving the data provided along lines 16 the laser driver 114 may receive a transmitter disable input along line 115 as illustrated in FIG. 4. This may be used to provide a windowing action to the laser driver signals provided to the laser diode to provide a burst transmission capability in a transmitter adapted for continuous mode operation to thereby provide dual mode operation. The laser driver 114 may also receive a clock input along line 34 which may be used to reduce jitter in some applications. As further illustrated in FIG. 4, a back facet monitor photodiode 116 is preferably provided to monitor the output power of laser diode 110. The laser output power signal from back facet monitor photodiode 116 is provided along line 117 to an automatic power control circuit 118 which adjusts a laser bias control input to the laser driver 114 and a laser modulation control input to the laser driver 114, along lines 120 and 122 respectively. These control signals allow the laser driver 114 to respond to variations in laser diode output power, which power variations may be caused by temperature variations, aging of the device circuitry or other external or internal factors. This allows a minimum extinction ratio between the modulation and bias optical power levels, e.g., 10 to 1, to be maintained. To allow rapid response to the modulation and bias control signals preferably a high speed laser driver is employed. For example, a Vitesse VSC7923 laser driver or other commercially available high speed laser driver could be suitably employed for laser driver 114.

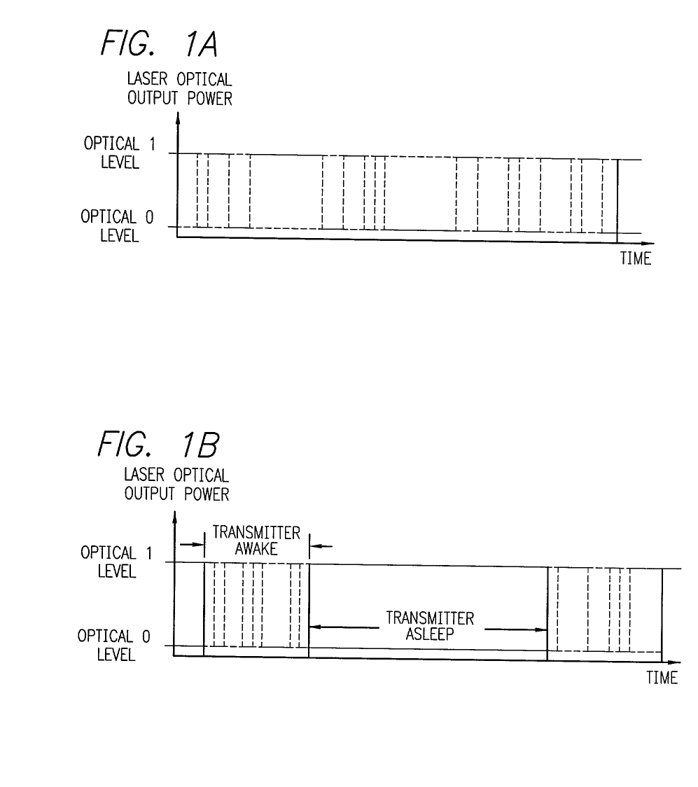

Still referring to FIG. 4, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 136 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform, for example, with a shape such as illustrated in FIG. 1A or 1B. A suitable digital signal recovery circuit is disclosed in co-pending U.S. patent application entitled “Fiber Optic Transceiver Employing Front End Level Control”, to Meir Bartur and Farzad Ghadooshahy, filed concurrently herewith. The digital signals output from digital signal recovery circuit 140 are provided to the back end of the receiver 132 which removes signal jitter, for example using a latch and clock signal to remove timing uncertainties, and which may also derive the clock signal from the digital signal if a clock signal is not available locally. In the latter case the receiver back end 132 comprises a clock and data recovery circuit which generates a clock signal from the transitions in the digital signal provided from digital signal recovery circuit 140, for example, using a phase locked loop (PLL), and provides in phase clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock may be available locally and the back end 132 aligns the phase of the incoming signal to the local clock, such that signals arriving from different transmitters and having differing phases are all aligned to the same clock. In this case the clock signals are inputs to the receiver back end from the local clock provided along line 34. A suitable clock and data phase aligner for such a synchronous application is disclosed in co-pending U.S. patent application entitled “Fiber Optic Transceiver Employing Clock and Data Phase Aligner”, to Meir Bartur and Jim Stephenson, filed concurrently herewith.

Referring to FIG. 5, transceiver 40 is illustrated corresponding to a single fiber implementation such as discussed above in relation to FIG. 3. The single fiber transceiver 40 includes the same general functional elements as described in relation to transceiver 10 above and like numerals are employed. The single fiber embodiment of FIG. 5 differs from the embodiment of FIG. 4 in that it employs optics 150 adapted to deliver modulated light to fiber 42 from the transmitter portion of transceiver 40 and to provide incoming modulated light from fiber 42 to the receiver portion. The optics 150 is generally illustrated schematically in FIG. 5 by first and second lenses 152, 154, however, optics 150 may include filters and beams splitters to separate the wavelengths of light corresponding to the transmit and receive directions in a wavelength division multiplexing implementation of the single fiber transceiver. In a time division multiple access implementation of the single fiber transceiver employing a single wavelength of light, optics 150 may simply include the lenses or other optics to optically couple both the transmit laser diode and the receive photodiode to fiber 42.

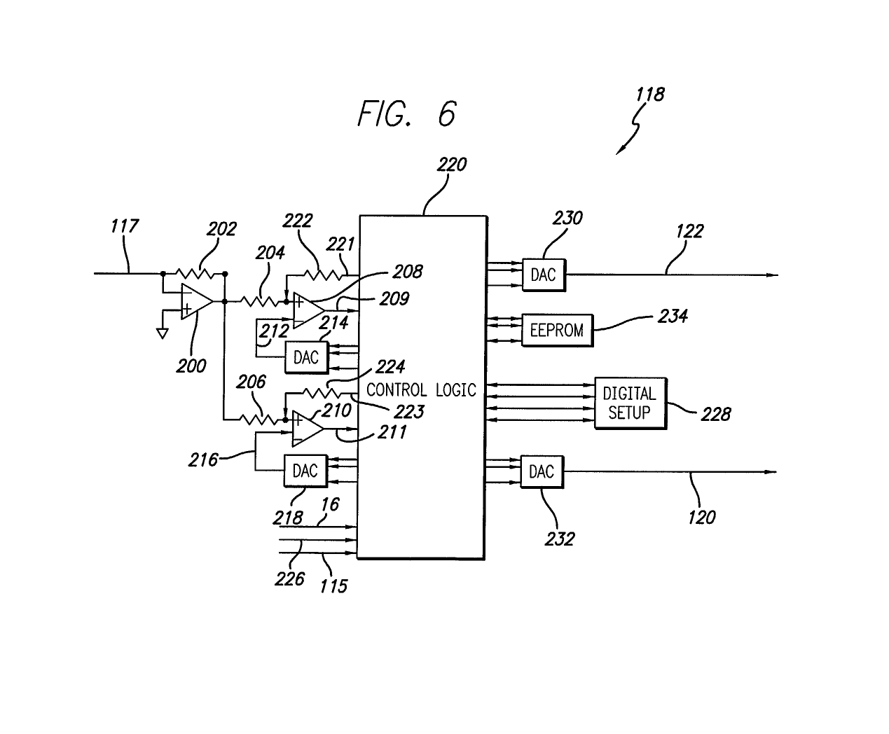

Referring to FIG. 6, a block schematic drawing of a preferred embodiment of the automatic power control circuit of the transmitter portion of the transceiver of the present invention is illustrated. The automatic power control circuit 118 provides a digital compensation of laser bias and modulation levels and provides for digital settings of the values, i.e., the ability to remember and store the digital values. This allows the laser driver to rapidly recover from on/off operational modes and at the same time to compensate for temperature related variations in laser output power or other variations caused by external factors or internal factors. This allows the extinction ratio to be maintained over time without impairing the ability of the transmitter to rapidly turn on and off to thereby allow high data rate burst transmission.

Referring to FIG. 6, the automatic power control circuit 118 receives the laser power monitoring photocurrent along line 117 from the back facet photodiode 116 (illustrated in FIGS. 4 and 5). This monitoring photocurrent is provided to transimpedance amplifier 200 which converts the photocurrent to a voltage. The transimpedance amplifier 200 also includes a feedback coupled resistor 202 as illustrated in FIG. 6. The voltage corresponding to the monitoring photocurrent from the back facet photodiode is provided from transimpedance amplifier 200 to first and second comparators 208 and 210, respectively, via first and second resistors 204 and 206. The first comparator 208 operates to compare the monitoring voltage from the transimpedance amplifier 200 with a reference level corresponding to the desired level for a modulation level (1 level) for the laser diode output. This reference level is provided along line 212 from digital to analog converter 214 which receives a digital value corresponding to the desired modulation level and converts it to a DC voltage which is provided along line 212. A suitable resolution for the digital to analog converter 214 is provided to give the desired voltage resolution for input to the comparator; e.g., an 8-bit resolution may be suitable for most applications. The digital reference level input to the digital to analog converter 214 is stored in a nonvolatile digital storage, for example, EEPROM 234. This digital value is preferably factory set during manufacture of the transceiver, but may also be altered during on-site testing during or after installation of the transceiver in the optical fiber network. On-site adjustment may be provided through a suitable digital interface, illustrated as digital setup interface 228 in FIG. 6. The digital to analog converter 214 may be implemented as a pulse width modulator and the output of the pulse width modulator may be filtered to provide the DC voltage. Comparator 208 may also receive a hysteresis control signal along line 221 from control logic 220, via resistor 222, as will be discussed in more detail below.

The monitoring voltage provided from transimpedance amplifier 200 to comparator 210 is similarly compared to a reference voltage level corresponding to a desired bias level (0 level) provided from digital to analog converter 218 along line 216. The digital to analog converter 218 receives an input digital reference level for the bias or 0 level and converts it to a DC voltage which is provided along line 216. The digital to analog converter 218 may also be implemented as a pulse width modulator and the output of the pulse width modulator filtered to provide the DC voltage. The digital reference level provided to digital to analog converter 218 is similarly stored in nonvolatile memory such as EEPROM 234 and may preferably be factory set and/or altered on-site as described in relation to the 1 setting. Comparator 210 may also receive a hysteresis control signal along line 223 from control logic 220, via resistor 224, as will be discussed in more detail below.

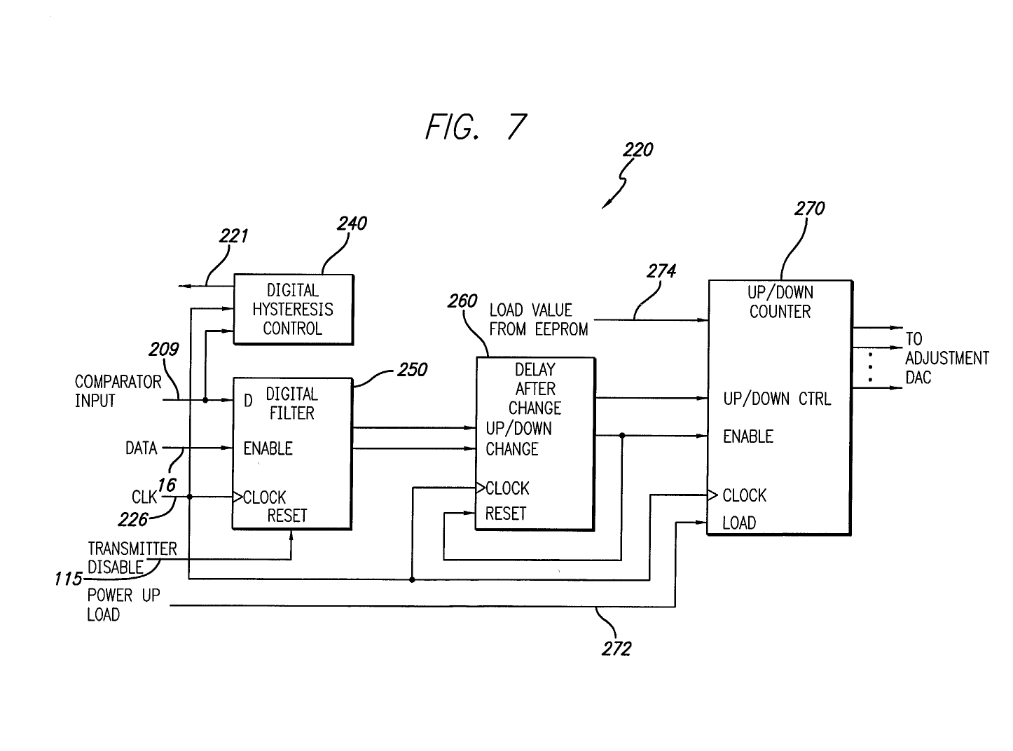

The outputs from the modulation level comparator 208 and the bias level comparator 210 are provided along lines 209 and 211, respectively, to control logic 220. A preferred embodiment of an implementation of control logic 220 will be described below in relation to FIG. 7. The analog signal provided along line 209 from comparator 208 corresponds to the difference of the monitored optical power of the modulation or 1 level of the laser diode to the desired modulation level and thus corresponds to an adjustment or error value in the laser output modulation level. For example, this error value may correspond to a change in laser output due to temperature variations, wear or aging of the transmitter circuitry, or other factors. The output along line 211 from comparator 210 in turn corresponds to the difference between the monitored optical power of the bias or 0 level of the laser diode to the desired bias level and thus corresponds to an adjustment or error value in the laser output bias level. This error value may be caused by the same factors leading to an error in the modulation level but the degree of the error may differ between the modulation and bias levels. Accordingly, the extinction ratio could be altered if a single adjustment were made to both levels or if a single error value was detected for both the modulation and bias levels. The error value provided along line 211 from comparator 210 is also provided to control logic 220.

Control logic 220 also receives as an input the data used to modulate the laser diode, provided along line 16, and an in phase clock signal provided along line 226. The clock signal may be generated locally in the transmitter or may be provided from the external data source (along line 34 in FIG. 2) in parallel with data on line 16. The clock and data values provided to the control logic 220 are used to selectively enable and disable, or sample, the output of comparators 208 and 210 so that the modulation level control is only asserted when a high or 1 level is being transmitted and correspondingly a bias level control is only asserted when a zero or low level is being transmitted. Since the data being transmitted is known along with the clock this allows precise control of the modulation and bias level (1 and 0 level) adjustments.

Finally logic 220 receives as an input the transmitter disable used to disable the transmitter, provided along line 115. The transmitter disable signal keeps the control logic from adjusting the laser power while the transmitter is disabled.

The error or adjustment values provided from comparators 208 and 210 to the control logic 220 are correlated with the 1 and 0 data values being transmitted, as noted above, and converted to digital adjustment values by the control logic 220. The digital adjustment values from the control logic are converted to DC voltage control values by digital to analog converters 230 and 232, respectively. The modulation level (1 level) control signal is thus output along line 122 to the laser driver 114 (shown in FIGS. 4 and 5) to adjust the modulation level and the laser bias (0 level) control is output along line 120 to the laser driver 114 to adjust the bias level. The digital adjustment values are also stored for immediate use for the next consecutive burst. These current 1 and 0 adjustment values may be stored in nonvolatile memory 234 or in a volatile memory, such as a RAM, in control logic 220, e.g., in a microprocessor implementation of control logic 220. This allows the desired laser power to be immediately reestablished for each new burst and temperature variations, wear, aging and other effects to be compensated for independently for the 1 and 0 levels. This in turn allows the desired extinction ratio to be maintained and data recovery accuracy to be maintained despite temperature variations, wear, aging and other effects.

During system start up the control logic circuit 220 reads the starting values for the adjustment values for the digital to analog converters 230 and 232 and the digital reference levels for input to the digital to analog converters 214, 218 from the nonvolatile digital storage, for example, EEPROM 234. The starting values for the adjustment values for the digital to analog converters 230 and 232 may be the last adjustment values stored from the prior system operation or may be initialized from a zero adjustment at each start up cycle. The digital reference levels for input to the digital to analog converters 214, 218 are preferably factory set and stored during manufacture of the transceiver, but may also be altered during on-site testing during or after installation of the transceiver in the optical fiber network. On-site adjustment may be provided through a suitable digital interface, illustrated as digital setup interface 228 in FIG. 6. For example, digital setup interface 228 may be a standard serial peripheral interface (SPI) bus operating in a slave mode. This type of bus requires 4 signal lines: (1) Master In, Slave Out (MISO), which is the data output; (2) Master Out, Slave In (MOSI) which is the data input; (3) Serial Clock (SCLK), which is the clock input; and (4) Chip Select (CS) which selects the chip. The digital setup interface 228 can also allow a computer or microcontroller to monitor the current values of the digital settings and adjust their settings by writing them to EEPROM 234 to be used for the next power up sequence. EEPROM 234 may also be accessed via an SPI bus, but in this case the control logic circuit 220 acts as the master.

As an alternate to the SPI bus, the I2C bus may be used. The I2C bus requires a serial clock (SCI) and bidirectional data (SDI). Finally the address of the I2C interface needs to be determined from hardware jumpers (1 to 7 bits) or may be read from the EEPROM during power up initialization.

Referring to FIG. 7 a block schematic drawing of a preferred implementation of the control logic circuit 220 employed in the digital automatic power control circuit of FIG. 6 is illustrated. FIG. 7 illustrates a logic design, but a microprocessor or a controller can be used as well. The logic design may be implemented in a gate array circuit, dedicated IC, or in a combination of IC and discrete components. Also, the illustrated implementation is a basic implementation of the control logic circuit. Further functionality, like gain compensation for the TIA 200, channel level calibration at the time of manufacturing, scaling for actual power levels, temperature compensation if necessary, end of life detection (e.g., using an additional current monitoring circuit and algorithmic comparison of current at power for specific temperature with stored values during manufacturing) could also be implemented in the control logic circuit 220 via a processor or logic design.

The control logic circuit 220 has as an input two bit streams corresponding to the sampled comparator (208 or 209) output being high or low, whose value over time will indicate if the bias and modulation adjustment values provided to digital to analog converters 230 and 232 need to be increased or decreased. The control logic illustrated in FIG. 7 shows the circuitry for processing the logic 1 or modulation channel only. The logic 0 channel is exactly the same except the Data Input must be low instead of high to enable the channel, and the channel operation is therefore described once for brevity. The bit streams from the comparators (208 and 210) are fed through a digital filter 250 and are used to increment or decrement counter 270. The counter value is provided as the adjustment value to digital to analog converters 230 and 232. The control logic sets the 1 adjustment digital to analog converter 230 value so the monitored voltage output from transimpedance amplifier 200 equals the reference voltage output on line 212 when the laser data is a logic 1. The control logic sets the 0 adjustment digital to analog converter 232 value so the monitored voltage output from transimpedance amplifier 200 equals the reference voltage output on line 216 when the laser data is a logic 0.

The digital filter 250 filters the incoming bit streams from the comparators (208 and 210). The digital filter 250 also receives the clock signal on line 226 and the data on line 16, to clock and enable inputs, respectively. The filter 250 operates to stabilize the loop for the speed of the back facet diode 116, transimpedance amplifier 200, and comparators (208 and 210) to prevent the system from oscillating. For example, the digital filter 250 may be comprised of a serial to parallel shift register and the outputs of the shift register must be all 1's or all 0's before a valid output is recognized. This will enable a change only after a set amount of consecutive 1's or 0's. Finally if the transmitter is disabled through 115, the digital filter 250 will be reset to prevent the power from being adjusted while the transmitter is disabled.

Still referring to FIG. 7, the delay after change circuit 260 allows the adjustment digital to analog converters (230, 232) to be updated at a rate not to exceed the loop speed. The back facet diode 116, transimpedance amplifier 200, and comparators (208 and 210) may be faster than the adjustment digital to analog converters (230, 232). Therefore the rate of change to the adjustment digital to analog converters (230, 232) must be controlled to prevent the circuit from oscillating.

The up/down counter 270 maintains the current digital value for the adjustment digital to analog converters (230, 232). At power up, the up/down counter 270 is loaded with the value stored in EEPROM 234 along line 274 in response to a load signal on line 272. If the filter output determines that the current needs to be increased, then the counter in incremented one count. If the filter output determines that the current needs to be decreased, then the counter is decremented one count.

An optional digital hysteresis control circuit 240 can be used to prevent oscillation in the comparators 208 or 210. In most analog comparator designs, a portion of the output is fed back to the non-inverting input of the comparator to prevent oscillation. The digital hysteresis control circuit 240 may be designed to feed back a signal to the comparators 208 (or 210), along lines 221 (or 223, shown in FIG. 6). The feedback alternatively may be provided after the digital filter 250, to apply the hysteresis for a fixed time after the change is detected. Alternatively, digital hysteresis control circuit 240 may implement a combination of these. Finally the design may implement a different hysteresis algorithm for a positive transition than is used for a negative transition to increase noise immunity.

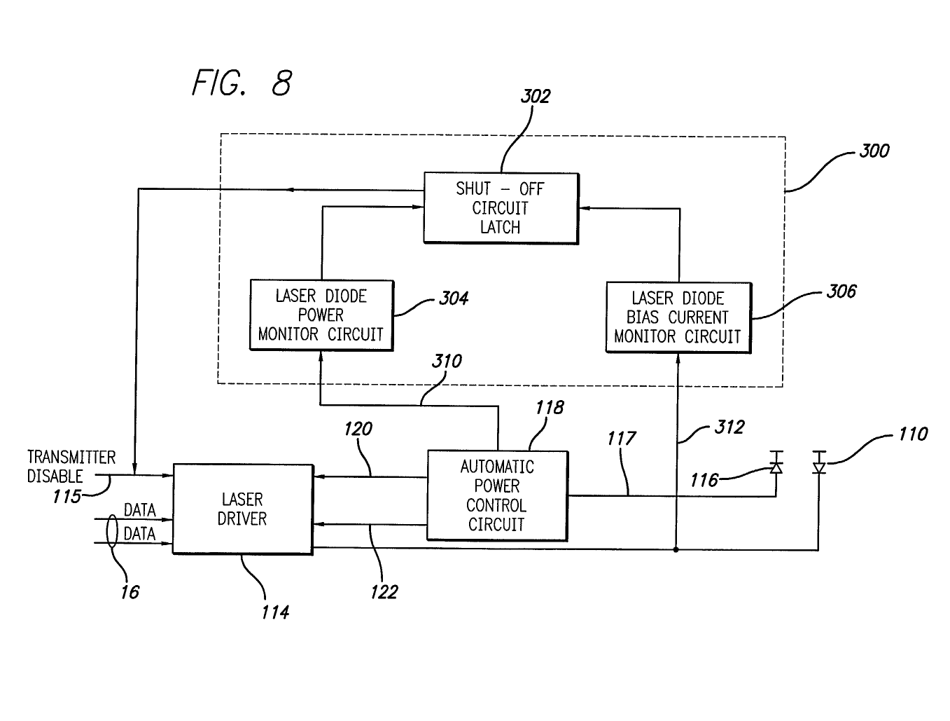

Referring to FIG. 8, an alternate embodiment of the transmitter of the present invention is illustrated employing a shut-off circuit. The transmitter elements described previously are provided like numerals and accordingly the description thereof will not be repeated. As shown in FIG. 8, the shut-off circuit 300 is coupled to monitor both the laser diode drive current along line 312 and the monitored laser diode power provided along line 310 from automatic power control circuit 118. The monitored laser diode drive current is provided to laser diode drive current monitor circuit 306 while the monitored laser data power is provided to laser diode power monitor circuit 304. Both the values are compared in the respective circuits to factory set maximum values for the laser drive current and monitored laser diode power. If either of these values exceed the factory set level a transmitter disable signal is provided to the shutoff circuit latch 302. This circuit holds the shutoff value in the circuit latch and provides the shutoff signal along the transmitter disable line 115 to laser driver 114. This thus provides a safety stop for the transmitter preventing damage to the transmitter or other circuitry due to overdriving of the laser diode. Furthermore, the laser output may be maintained within a safety range to prevent any danger to equipment operators.

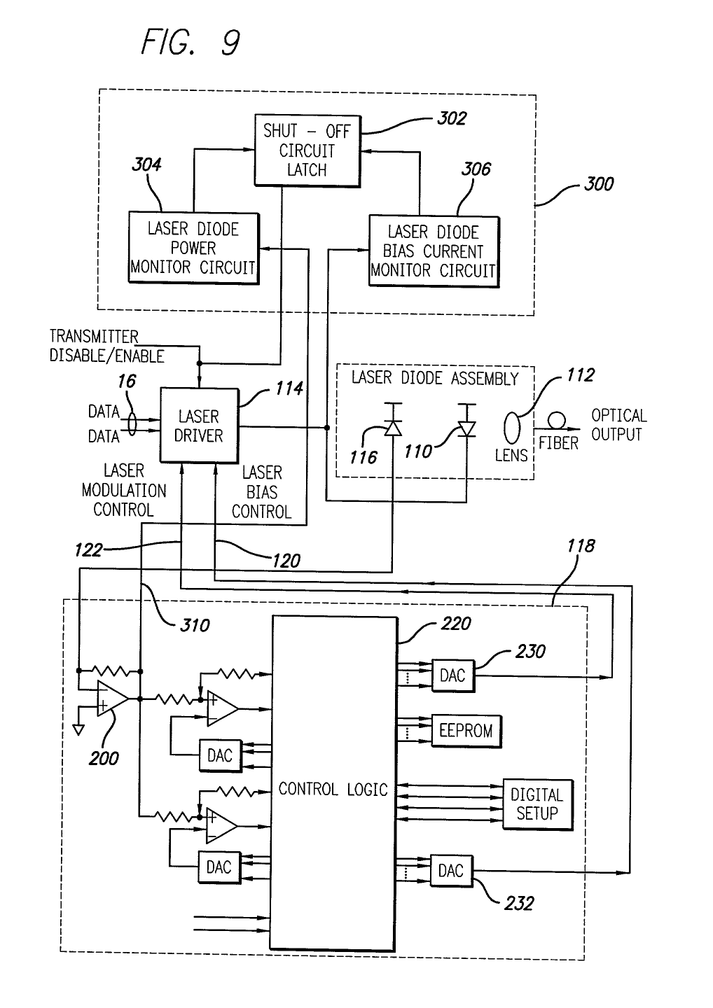

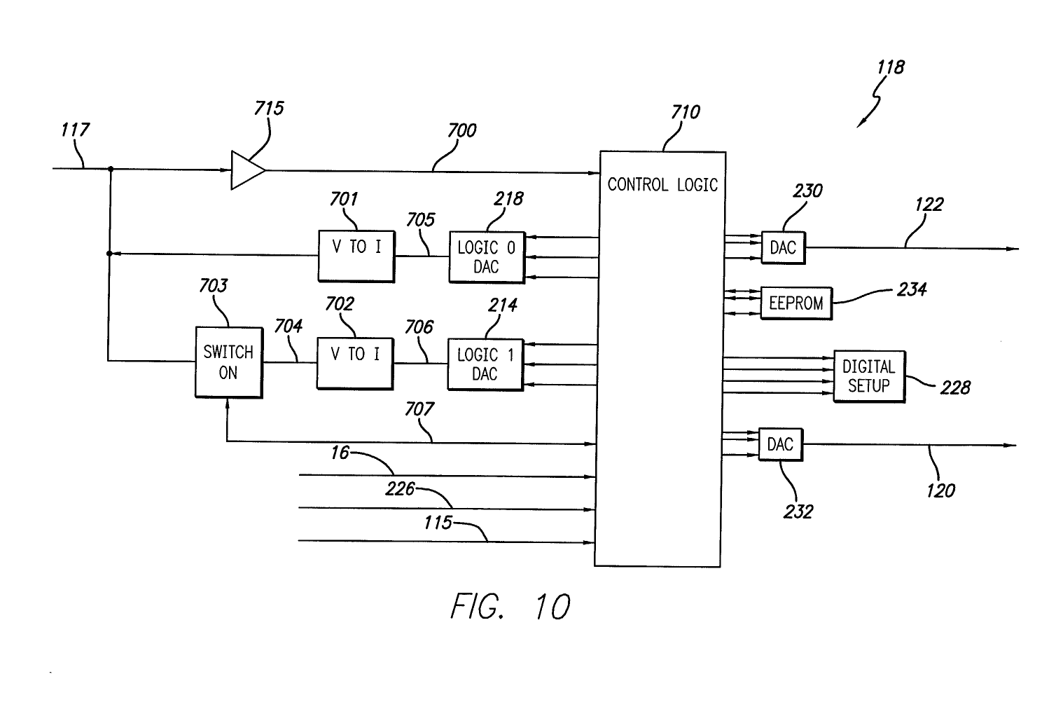

Referring to FIG. 9, a detailed embodiment of an optical transmitter employing the safety shut-off circuitry 300 and the automatic power control circuitry 118 is illustrated. The embodiment of FIG. 9 illustrates a configuration combining the previously described embodiments and accordingly like numerals are employed and the operation thereof need not be described in detail. As illustrated in FIG. 9 the laser diode power monitoring signal provided along line 310 to the laser diode power monitoring circuit may be advantageously taken from the output of the transimpedance amplifier 200 of the automatic power control circuit 118. The output of the transimpedance amplifier 200 is a voltage corresponding to the photocurrent from the back facet photodiode 116 and may therefore be employed by the laser diode power monitoring circuit 304 to detect when a maximum laser output power is exceeded.

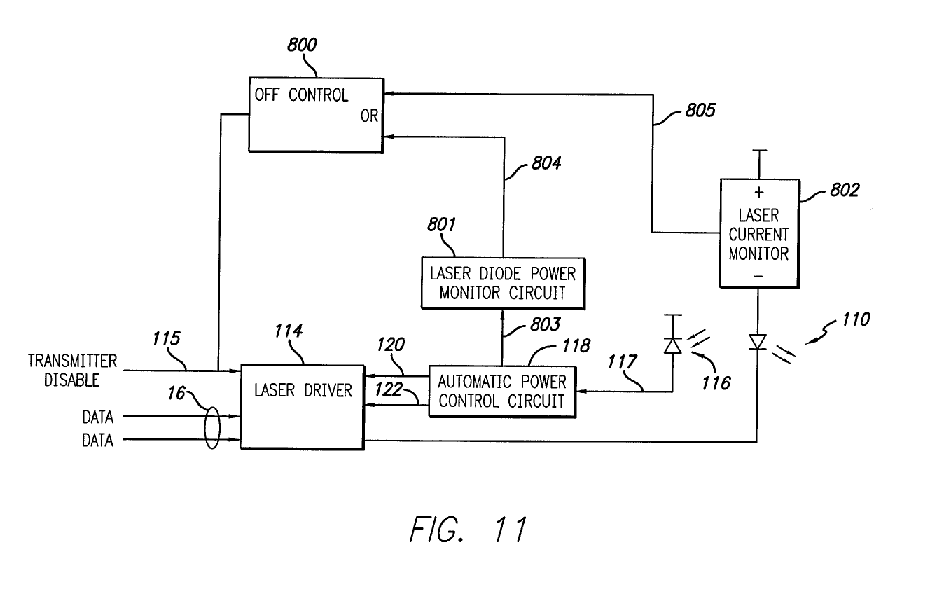

An alternate embodiment of the digital automatic power control circuit employing a current comparator front end for the digital compensator is shown in FIG. 10. The current comparator operates in a current mode and may provide faster response times and may be easier to implement in an ASIC design. The output of a current comparator is logic 1 if the current into its input is positive and logic 0 if the current into its input is negative. Current comparators are used instead of voltage comparators in order to increase speed of operation. They can be manufactured using an operational amplifier where one if the inputs is grounded and the other is tied to the current to be monitored.

Referring to FIG. 10, the output from the back facet diode connects to 117 and its current is offset by the current from the logic 0 V to I (Voltage to Current Converter) 701 and the logic 1 V to I 702. If current flows into the input of the current comparator 715 then its output is high. If current flows out of the input to the current comparator 715, then its output is low. If the data is sensed to be a logic 1 by the control logic 710 through wire 16, the switch 703 is turned on to allow the current through wire 704 to connect to the current comparator 715.

The control logic 710 sets the logic 1 threshold by setting the voltage at DAC 214. The voltage to current converter (V to 1) 702 converts the voltage from the DAC (wire 706) to a current. Similarly the control logic 710 sets the logic 0 threshold by setting the voltage at DAC 218. The voltage to current converter (V to I) 701 converts the voltage from the DAC (wire 705) to a current.

The rest of the control logic 710 behaves like the control logic 220 shown in FIG. 6.

An alternative embodiment of the optical receiver of FIG. 8 employing an alternate shut-off circuit is shown in FIG. 11. This shut-off circuit differs as the total laser current is monitored, not just the bias current. The circuit will reduce the output power if the laser current is too high as measured by laser current monitor 802 or the laser power is too high as measured by laser diode power monitor circuit 801. The circuit also differs in that off control 800 does not latch the laser in the off condition. It turns the laser off for a minimum of 50 ms and turns the laser back on. The response time of the laser diode power monitor circuit 801 and the laser current monitor 802 is less than 5 μs which provides a duty cycle of 1000 to 1 or greater. This reduces the average output power by 1000 times which is below the eye safety standards.

The laser current monitor 802 can be implemented in different ways. One way is to use an asymmetrical current mirror. As the laser current increases, the output current of the mirror increases. When the current reaches the factory preset threshold, the off control 800 turns the laser off for at least 50 ms. Another way is to develop a voltage across a small value resistor which senses the laser current. A comparator can be used to compare the voltage across the resistor to a factory preset value. When the laser current exceeds the preset value, the off control 800 turns off the laser off for at least 50 ms.

The laser diode power monitor circuit, monitors the voltage at the output of the transimpedance amplifier. This voltage is proportional to the laser power. A voltage comparator can compare this voltage against a factory preset value. When the voltage exceeds the preset value, the off control 800 turns the laser off for at least 50 ms.

In view of the above detailed description, it will be appreciated that the optical transmitter of the present invention allows independent digital adjustment of the laser current for output 1 and output 0 conditions. These values may be programmed from an external computer or microcontroller. The digital automatic power control of the optical transmitter of the present invention further allows the compensation values to be preset at power up which removes the power up delay of analog feedback loop compensation. In addition, these values may also be read and stored by an external computer or microcontroller. Furthermore, the automatic power control operates from a frequency of 0 Hz to GHz range. The upper limit is determined only by the speed of the logic, TIA amplifier, and comparators.

Therefore, it will be appreciated that the present invention provides an optical transmitter and/or transceiver adapted for use in an optical fiber data transmission system which is capable of transmitting data at high data rates in burst mode. The present invention further provides an optical transmitter or transceiver which can provide such capability without added cost or complexity. The present invention further provides an optical transmitter or transceiver capable of operating in both burst and continuous mode.

Although the present invention has been described in relation to specific embodiments it should be appreciated that the present invention is not limited to these specific embodiments as a number of variations are possible while remaining within the scope of the present invention. In particular, the specific circuit implementations illustrated are purely exemplary and may be varied in ways too numerous to enumerate in detail. Accordingly they should not be viewed as limiting in nature

What is claimed is:

1. An optical transmitter, comprising:
a laser diode;
a laser driver having a data input for receiving input data and providing a drive signal to the laser diode corresponding to the input data;
a laser diode power monitoring photodiode for monitoring the laser optical output power and providing a laser power monitoring signal; and
an automatic power control circuit coupled to receive the laser power monitoring signal, the automatic power control circuit comprising a comparator for comparing the monitored laser power to a reference level and a control circuit, coupled to the comparator output, for providing a digital power control value corresponding to the difference between the monitored laser power and the reference level, the automatic power control circuit employing the digital power control value to provide a power control signal to the laser driver.

2. An optical transmitter as set out in claim 1, wherein said automatic power control circuit further comprises a transimpedance amplifier for converting the laser power monitoring signal to a voltage signal and providing the voltage signal to the comparator.

3. An optical transmitter as set out in claim 1, wherein said automatic power control circuit further comprises a nonvolatile storage for storing said reference level as a digital reference value.

4. An optical transmitter as set out in claim 1, wherein said automatic power control circuit further comprises a memory for storing said digital power control value.

5. An optical transmitter as set out in claim 4, wherein the transmitter transmits bursts of modulated light and wherein said memory stores said digital power control value between bursts.

6. An optical transmitter as set out in claim 3, wherein said automatic power control circuit further comprises a reference digital to analog converter for converting the digital reference value to a DC voltage and providing the DC reference voltage to said comparator.

7. An optical transmitter as set out in claim 1, wherein said control circuit comprises a counter which is coupled to receive the comparator output and which provides the digital power control value as an output.

8. An optical transmitter as set out in claim 7, wherein said counter is incremented when the laser power level is below the reference level.

9. An optical transmitter as set out in claim 7, wherein said counter is decremented when the laser power level is above the reference level.

10. An optical transmitter as set out in claim 7, wherein said control circuit further comprises a digital filter coupled between the comparator and the counter.

11. An optical transmitter as set out in claim 10, wherein said control circuit further comprises a digital hysteresis control circuit coupled to the comparator output and providing a feedback signal thereto.

12. An optical transmitter as set out in claim 1, further comprising a shut-off circuit, coupled to the automatic power control circuit, for shutting off the laser driver if the monitored power exceeds a preset safety level.

13. An optical transmitter as set out in claim 12, wherein the shut-off circuit comprises a laser power monitoring circuit receiving a laser power monitoring signal from the automatic power control circuit and a shut-off circuit latch.

14. An optical transmitter as set out in claim 13, wherein the shut-off circuit further comprises a laser diode driver current monitoring circuit receiving the laser drive current from the laser driver and wherein the shut-off circuit shuts off the laser driver if the laser drive current exceeds a preset safety level.

15. An optical transmitter as set out in claim 1, further comprising a digital to analog converter for converting the digital power control value to an analog power control signal and wherein the automatic power control circuit provides the analog power control signal to control the laser driver.

16. An optical transmitter, comprising:
a laser diode;
a laser driver having a data input for receiving input data and providing a drive signal to the laser diode corresponding to the input data, the drive signal having a modulation level for a high data input logic level and a lower bias level for a low input logic level;
a laser diode power monitoring photodiode providing a laser power monitoring signal; and
an automatic power control circuit coupled to receive the laser power monitoring signal, the automatic power control circuit comprising a first comparator for comparing the laser power to a modulation reference level, a second comparator for comparing the laser power to a bias reference level, a control circuit, coupled to the first and second comparators, for providing a digital modulation power control value corresponding to the difference between the laser power for a high input data logic level and the modulation reference level and a digital bias power control value corresponding to the difference between the laser power for a low input data logic level and the bias reference level, the automatic power control circuit controlling the modulation level of the laser driver drive signal in response to the digital modulation power control value and controlling the bias level of the laser driver drive signal in response to the digital bias power control value.

17. An optical transmitter as set out in claim 16, wherein said control circuit comprises a clock input for receiving a clock signal in phase with the input data.

18. An optical transceiver, comprising:
a transmitter comprising a laser diode providing modulated optical signals, a laser driver coupled to a data input and providing a drive signal to the laser diode corresponding to the input data, a laser diode power monitoring photodiode providing a laser power monitoring signal, and digital power control means for comparing the laser power monitoring signal to a reference value, deriving digital power adjustment values corresponding to the difference, controlling the laser driver based on the adjustment values, and storing the digital power adjustment values; and
a receiver comprising a front end coupled to receive input modulated light from an optical fiber and providing a corresponding digital electrical signal and a back end coupled to receive the digital electrical signal and provide output clock and data signals.

19. A burst mode optical data transmission system, comprising:
a plurality of transmitters providing burst mode modulated optical signals, each of said transmitters including optical power monitoring means for monitoring the output optical power and digital power control means for controlling the optical power based on the difference between the monitored output optical power and a reference value, the digital power control means including means for storing a digital value corresponding to the control between bursts;
at least one optical fiber optically coupled to the transmitters; and
a receiver optically coupled to the fiber and receiving the burst mode modulated optical signals.

20. A method for transmitting data over an optical network in a burst mode, comprising:
providing modulated light to an optical fiber in a burst, the burst comprising a plurality of data bits;
monitoring the output optical power of the modulated light;
comparing the monitored output optical power to a reference value;
deriving a digital adjustment value based on the difference between the monitored output optical power and the reference value;
controlling the optical power based on the digital adjustment value;
placing the transmitter in a low power sleep mode after transmission of the burst; and
storing the digital adjustment value until transmission of the next burst.
